(19) United States
(12) Patent Application Publication
(10) Pub. No.: US 2008/0104513 A1
(43) Pub. Date: May 1, 2008

(54) System for retrieving information

(75) Inventor: Jan Olaf Krogh, Hellerup (DK)

Correspondence Address: STERNE, KESSLER, GOLDSTEIN & FOX P.L.L.C., 1100 NEW YORK AVENUE, N.W., WASHINGTON, DC, 20005, US

(73) Assignee: Joker Media ApS, Hellerup (DK)

(21) Appl. No.: 11/586,738

(22) Filed: Oct. 26, 2006

(51) Int. Cl. G06K 9/20; G06F 3/048; G06K 7/00

(52) U.S. Cl. 715/711; 382/312

(57) ABSTRACT

A graphical user interface system for facilitating the retrieval of information relating to at least one predetermined category of information. The system comprises a computer, a user controlled pointing device and a graphic display, said graphic display comprising a number of pixels for generating an image comprising x times y pixels based on information from said computer. The image comprises a background with a superposed grid defining a number of sectors, each sector comprising a number n of pixels. Furthermore, the system comprises indicating means for indicating in a sector defined by said grid and displayed on said graphic display, the existence of a piece of information for that sector, where said piece of information relates to the background corresponding to that sector. Furthermore, said indicating means indicates that said piece of information relates to said at least one category of information. The system also comprises a graphical representation of a pointer movable in response to said user controlled pointing device, so as to allow user selection of a specific sector, and means for displaying said piece of information in response to user selection of that specific sector.

### BACKGROUND OF THE INVENTION

The present invention relates to a system for retrieving information, in particular a to a graphical user interface system facilitating the retrieval of information relating to at least one predetermined category of information.

The Internet as a means for finding relevant information is of still growing importance. Many providers of search facilities compete for attracting the interest of the potential users. In this respect an interface, which is intuitive and easy to use, is of importance.

Furthermore an important factor is the user's ability to quickly gain access to large quantities of information, while not at the same time being flooded with useless information. Simply listing a number of relevant database entries, does not do this, not even when the entries have been searched out by using keywords, and ranked by relevance algorithms.

### BRIEF SUMMARY OF THE INVENTION

According to a first aspect of the invention, this object is achieved by providing a graphical user interface system for facilitating the retrieval of information relating to at least one predetermined category of information, said system comprising a computer, a user controlled pointing device and a graphic display, said graphic display comprising a number of pixels for generating an image comprising x times y pixels based on information from said computer, said image comprising a background with a superposed grid defining a number of sectors, each sector comprising a number n of pixels, said system comprising indicating means for indicating in a sector defined by said grid and displayed on said graphic display, the existence of a piece of information for that sector, where said piece of information relates to the background corresponding to that sector, and where said indicating means further indicates that said piece of information relates to said at least one category of information, said system comprising a graphical representation of a pointer movable in response to said user controlled pointing device, so as to allow user selection of a specific sector, and said system comprising means for displaying said piece of information in response to user selection of that specific sector.

Such a graphical user interface system allows the user to quickly overview several thousands of potentially relevant items, and quickly gain access to those appearing most relevant.

According to a preferred embodiment, said indicating means in said sector comprises one or more of: a color coding, a symbol, and blinking. This allows easy identification of sectors, for which information exists, and the nature of such information. In particular the use of colors has been found efficient.

According to a further preferred embodiment, a set of several different indicating means is used, each different indicating means representing a different predetermined category of information in a set of predetermined categories of information. This allows the same indication means to be used with a wide range of different screens relating to different types of information.

According to another preferred embodiment of the invention, the graphical user interface further comprises means for user selection between different sets of predetermined categories of information represented by said indication means. This allows the user to select an appropriate screen relating to his need for information.

According to yet another preferred embodiment of the invention, said piece of information is automatically displayed when said graphical representation of a pointer enters a sector for which a piece of information exists. This allows easy navigation for the user over the selected screen, while information being automatically presented to him.

According to another preferred embodiment, said user controlled pointing device comprises activation means for activating the user selection of a sector in order to display said piece of information. This allows the user to actively select the information to be displayed, e.g. to have further information displayed upon said automatic display.

According to a further preferred embodiment, said background is a map and said information relating to said background is a geographical location. This efficiently allows the user to select relevant information not only based on category, but also based on the geographical location, which is in may respects also an important parameter in terms of relevance of the information searched.

According to a further embodiment of, said graphical user interface system, comprises means for allowing a user to add a piece of information relating to a sector, and in response to such addition have the existence of such information indicated for that specific sector.

This increases the versatility of the system because any user may add pieces of information to be displayed to further users. Easy user access to placing pieces of information in the system, will make the users more inclined to do so, thus adding the value of the graphical user interface system as a search utility. This is in particular the case if according to a further preferred embodiment of the graphical user interface system according to the invention, said means for allowing the user to add a piece of information to a sector comprises an interactive process.

According to a second aspect of the invention, the object is achieved by a system for facilitating the retrieval of information relating to at least one predetermined category of information, said system comprising a computer and a graphic display, said graphic display comprising a number of pixels for generating an image comprising x times y pixels based on information from said computer, said image comprising a background with a superposed grid defining a number of sectors, each sector comprising a number n of pixels, said system comprising a database with pieces of information corresponding to at least some of the sectors, said system comprising indicating means for indicating in a sector defined by said grid and displayed on said graphic display, the existence and category of a piece of information for that sector, so as to allow easy identification of potentially relevant entries in said database.

According to a preferred embodiment of the second aspect of the invention, said system further comprises a user controlled pointing device for controlling a graphical representation of a pointer movable in response to said user controlled pointing device, so as to allow user selection of a specific sector, and said system comprises means for displaying said piece of information in response to user selection of that specific sector. This allows easy navigation for the user over the selected screen, while information being automatically presented to him.

According to a further preferred embodiment of the second aspect of the invention, said indicating means in said sector comprises one or more of: a color coding, a symbol, and blinking. This allows easy identification of sectors, for which information exists, and the nature of such information.

According to another embodiment of the second aspect of the invention, said system comprises means for allowing a user to add a piece of information relating to a sector, and in response to such addition have the existence of such information indicated for that specific sector.

This increases the versatility of the system as a utility of retrieval of information because any user may add pieces of information to be displayed to and benefiting the searches of further users using the system for retrieval of information. Moreover, easy user access to placing pieces of information in the system, will make the users more inclined to do so, thus adding the value of the graphical user interface system as a search utility. This is in particular the case if according to a further preferred embodiment of the system, said means for allowing the user to add a piece of information to a sector comprises an interactive process.

### BRIEF DESCRIPTION OF THE DRAWINGS/FIGURES

Examples of the invention will now be explained below with reference to the highly schematical drawings, in which

FIG. 1 illustrates an exemplified view of a graphical user interface according to the invention,

FIG. 2 illustrates the graphical user interface according to FIG. 1 with a mouseover pop-up window displayed in response to the current position of the pointer,

FIG. 3 illustrates the graphical user interface according to FIG. 1 with a pop-up window displayed in response to the user clicking a sector of the interface for which information exists,

FIG. 4 illustrates the graphical user interface according to FIG. 1 with a pop-up window displayed in response to the user clicking a sector of the interface for which no information exists,

FIG. 5 illustrates a main screen used for accessing the graphical user interface according to FIG. 1, and

FIG. 6 illustrates a sequence of steps for buying a sector displayed in said graphical user interface.

### DETAILED DESCRIPTION OF THE INVENTION

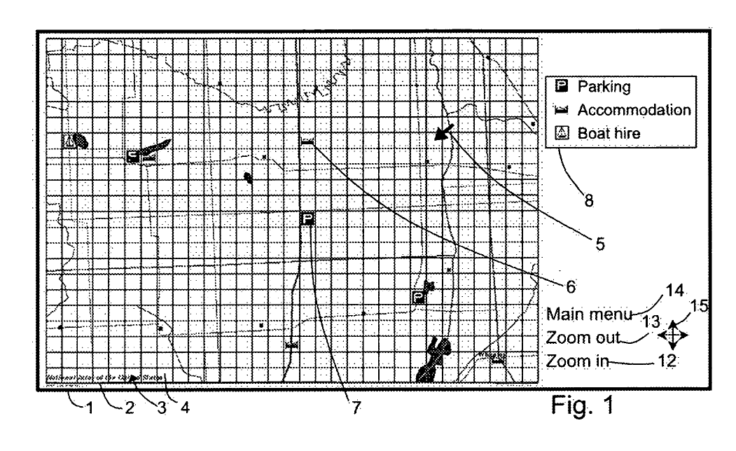

In FIG. 1 an exemplified computer screen display 1 for a graphical user interface according to the invention is illustrated. It must be emphasized that for the sake of clarity of this description, the exemplified computer screen display 1 is a simplified illustration. The computer screen display 1 comprises a grid 2 provided as an overlay on a map 3. The grid defines a number of sectors 4. In the example illustrated, the number of sectors 4 is 682, viz. 31 times 22 square sectors 4 arranged in a rectangle. Again, this is merely for illustration purpose, in practical use on a present day computer screen, a number of e.g. 6000 to 8000 sectors 4 would be more realistic. In that case each sector 4 would be approximately 10 times 10 pixels on the computer screen. Also, both the map 3 and the overlay grid 2 would normally be represented in color. In this respect, it should be noted that the sectors 4 need not be square, they could be any of many other shapes e.g. triangular or hexagonal, the grid then being a honeycomb type of grid.

As it is commonly known, the user may navigate the computer screen display 1, by means of a pointer 5, displayed on the screen and movable thereon in response the user's interaction with a physical pointing device such as a mouse or a track-ball, or even his own finger if the screen is a touch sensitive screen.

As can be seen in FIG. 1, symbols 6, 7 have been placed in some of the sectors 4. The existence of such a symbol 6, 7 in a sector 4 indicates that information is available. The information would normally relate to the location of the sector 4 and in some way to the symbol. In this respect, it should be noted that the use of symbols 6, 7 is not currently considered the best mode by the inventor. In fact, the use of differently colored sectors is preferred, as a simple coloring of the sector would be more readily identifiable on the background than a complex symbol. This is in particular the case, if, as preferred, the sector is merely 100 pixels in size, viz. 10 times 10 pixels. With just a few colors, e.g. five to ten, it is possible to cover a wide selection of information in a set of relevant information items.

In the illustrated example, a legend 8, including a description of the symbols used in the grid, is placed in the top right-hand corner of the computer screen display 1. The description would in particular be of importance when instead of intelligible symbols, colors are used.

The user may navigate the computer screen display 1 using his physical pointing device, to move the pointer 5 around. In the situation of FIG. 1, the pointer is currently placed over a sector 4, for which no information exists. If however the pointer 5 is moved to a sector 4, for which information exists, this information may be displayed.

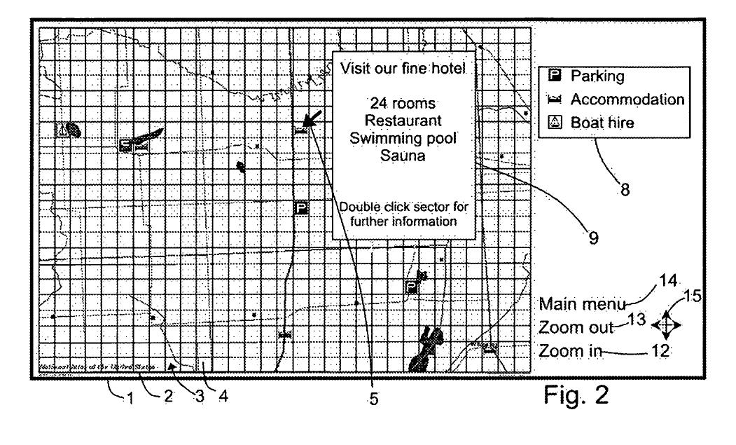

One way of displaying the information is illustrated in FIG. 2. Here an information display box 9 with information relating to the specific sector 4 is automatically displayed in response to the pointer being placed in that specific sector 4, and will preferably be displayed as long as the pointer is located in the sector 4. If the pointer 5 is moved to an adjacent sector 4, the information, if any, for that sector will be displayed in a new information display box 9. If no information exists for the adjacent sector 4, the information display box 9 will disappear.

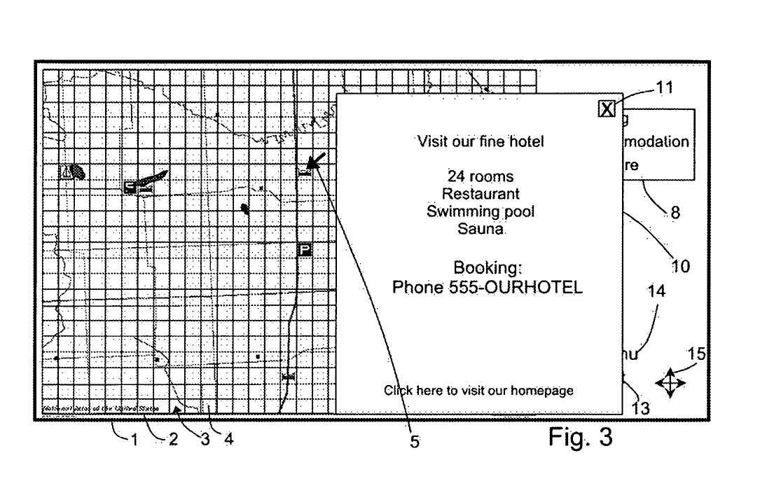

Another way of displaying the information is illustrated in FIG. 3. Here the information is not displayed automatically, but in response to user selection e.g. by clicking or double-clicking a button on his physical pointing device. Upon user selection a pop-up window 10 appears with the information. This pop-up window 10 preferably stays on the computer screen display 1 until the user actively closes it, e.g. by using his pointing device on a closing button 11, or until another sector 4 is selected.

As indicated in FIG. 2, by the text “Double click sector for further information”, the two ways of displaying information do no exclude each other, but rather supplement each other. Thus, if upon display of the information in the information display box 9, the user selects the sector 4, the pop-up window 10 would appear, and the display box 9 preferably disappears. As can be seen by comparing FIGS. 2 and 3, the information in the pop-up window 10 of FIG. 3 is more detailed that the information in the display box 9 in FIG. 2. The display box 9 could thereby be used as a teaser for quick navigation, while the pop-up 10 comprises detailed information of interest to the user, which may take some time to read. If the graphical user interface according to the invention is used in an internet context, the pop-up 10 could include a web-link representing an URL for a site with even more information.

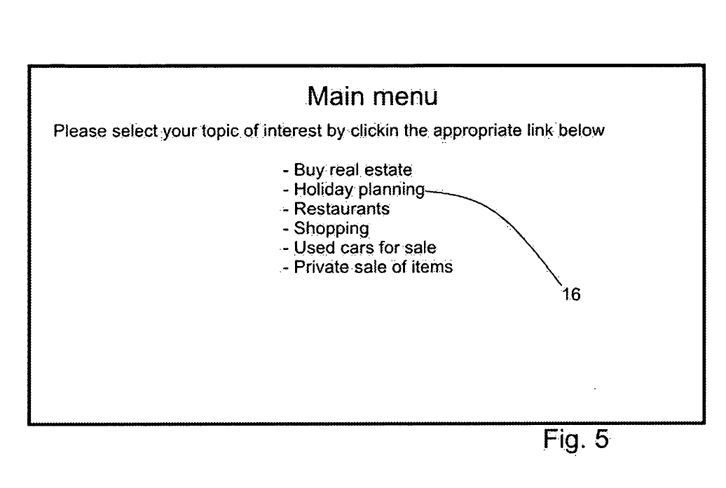

Returning now to FIG. 1, a number of selectable links or buttons 12, 13, 14 labeled “Zoom in”, “Zoom out”, “Main menu”, respectively are located in the lower right-hand corner of the computer screen display 1. Also located in the lower right-hand corner is a quadruple arrow 15. These can be selected by the user in order to arrive at different backgrounds displayed on the computer screen displays 1. Thus the “zoom in” 12 or “zoom out” 13 can be used to change the scale of the background, i.e. the map 3 in the illustrated example. The size of the grid 2 will preferably remain the same with respect to the computer screen display 1. At a given zoom level, the user may pan to adjacent areas not currently shown using the quadruple arrow 15. The “main menu” 14 will send the user back to a main menu, see FIG. 5, allowing for the selection between different kinds of sets of relevant information. In the example illustrated in FIGS. 1 to 4, the user would have arrived at these displayed backgrounds by clicking “holiday planning” 16 in FIG. 5, and possibly by clicking “Zoom in” 12 an appropriate number of times.

Thus, starting from the main screen of FIG. 5, the user easily gets to a computer display screen 1 showing a map 3 with the proper scaling for his needs and with indications relating to the relevant type of information. He can then readily identify the relevance of the information based on the geographical location of the sector 4 and the indication means, e.g. the color of the sector 4.

If he wants to buy real estate, he would select a map 3 of the area, where he intends to buy. Locations of real estate for sale would then be indicated by a set of indication means, such as symbols or color codings placed in appropriate sectors 4. With a proper indication, such as a color coding, corresponding to the price range, he would quickly identify any real estate affordable by him. Simple distinctive color coding in say five to ten different colors would suffice for this. Alternatively, if his focus was not on the price, he could instead select a map 3, where the set of indication means relates to another parameter, e.g. a color coding corresponding to the size of a house. If a sector comprises recently added information about e.g. new real estate for sale, this could be indicated by a blinking color.

By moving the pointer 5 to a specific sector 4, having a coloring corresponding to the desired price range, more information about the real estate would be displayed in a display box 9. If the information in the display box 9 triggers the interest of the user, further information could be revealed in a pop-up window 10 by selecting the sector 4, e.g. clicking or double clicking thereon. This pop-up window 10 could then contain contact details of the real estate agent or even an internet link to the estate agents internet internet page with relation to the real estate.

The skilled person would know that the graphical user interface system according to the invention could be used for easy retrieval of information relating to almost anything, but in particular for retrieval of information, for which the location is relevant. This could be for locating a sales point for items, such as cars, electronic goods, be it in commercial retail or private sale. The graphical user interface would also be very efficient for locating services, e.g. for finding a hospital, a doctor, a dentist, a psychiatrist, a chiropractor etc. It could be used for municipal information about the location of schools, kinder gardens, public libraries, the town hall, hospitals, retirement homes, day care, parks, playgrounds, etc. where each item would have the possibility of presenting themselves to the user, with a brief statement and a picture. For e.g. a public playground, the display box 9 could merely have the street address, whereas the pop-up window 10 could have details such as age range, facilities, number of benches for parents, and a photo of the playground.

The system according to the invention, however, not only allows the user to retrieve relevant information. He may also himself add information to the system. This is in particular relevant in an internet context, where everybody could buy the right to place information relating to a sector 4.

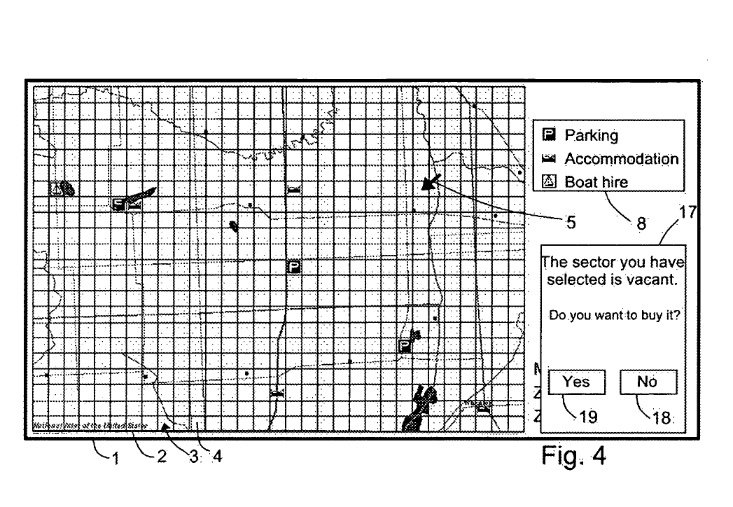

One way of doing so is illustrated in FIG. 4. Here the user has selected, e.g. by clicking or double-clicking, a vacant sector 4, i.e. a sector for which no information exists. The user is then prompted with the pop-up window 17, inviting him to buy the sector. If he is not interested, he may click the button 18 with the answer “No” using the button on his pointing device, and the pop-up window 17 will disappear. If, on the other hand, he is interested, he may click the button 19 with the answer “Yes”. This will send him through a series of sales screens allowing him to submit payment details, such as credit card details, and enter information to be displayed in a display box 9 and information to be presented in a pop-up window 10. He may also select the appropriate symbol or coding relevant for the information. Alternatively, this may be derived from an entry, e.g. if the indication means is a color coding corresponding to a real estate sales price or the size of a house for sale. This color coding could also include a color for people looking for a house in a specific place. When all necessary data has been entered by the user, the data is sent or uploaded to the provider of the service using the graphical user interface system according to the invention. The supplier of the service using the graphical interface system according to the invention would then store the information, and make the appropriate indication on one or more backgrounds to be displayed on a computer display screen 1, viewable and retrievable for any other user of the system being interested in the specific sector 4.

There is thus provided a commercially interesting system where any interested user may post relevant data, thus adding to the overall value of the graphical user interface system, because more relevant data becomes retrievable. Essentially, the more sectors 4 in the graphical user interface, for which data are stored, the better the graphical user interface becomes as a search utility for the user.

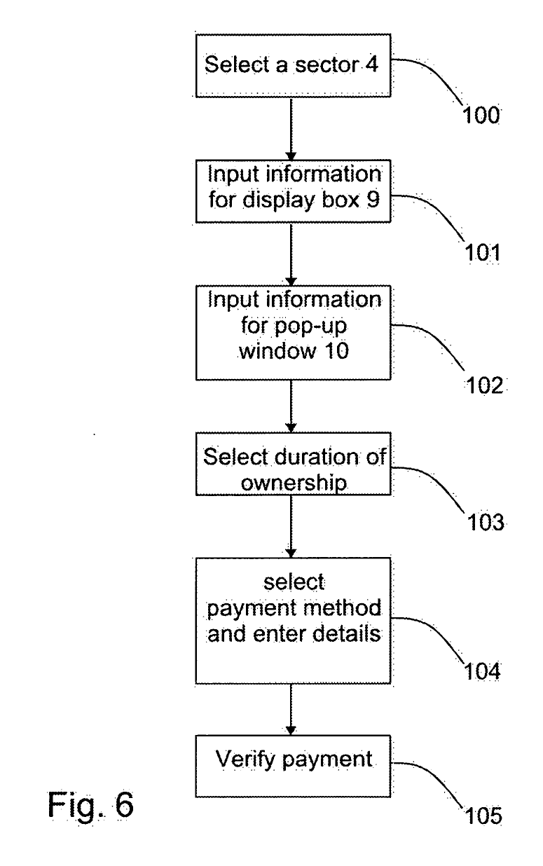

FIG. 6 illustrates a simple example of such a number of steps in the form of a flow chart. In box 100, the user selects a sector 4. Upon selection in box 100, the user is prompted in box 101 to enter information to be displayed in a display box 9. In box 102, be it on a separate screen, or on the same screen, the user may be prompted to enter information to be displayed in a pop-up window 10. In box 103, be it on another separate screen or still on the same screen, the user may be prompted to select a desired duration of ownership to the sector 4. In box 104, be it still on the same screen or on another separate screen, the user will be prompted to select a method of payment and enter his payment details. Finally, in box 105, the user would be prompted to verify the payment, at the price calculated for the sector and the given duration. Since the maps may be presented on different scales, the price for a large scale map 3, where a sector could cover most of a city, would differ from the price of a sector 4 on a small scale map 3 where a sector 4 would only cover a single or a few houses. In this respect, it should be noted that because geographical locations are covered by several maps 3 with different resolutions, the buyer may not only buy a sector 4 at one given resolution, but in fact buy the entire hierarchy of sectors 4 from the largest scale map 3, to a the smallest scale map 3. This would of course not block other users from buying sectors 4 on lower scale maps 3 or subhierarchies, but their sectors 4 would then not be visible on the largest scale map 3.

In this manner, someone who has an interest in having information displayed in relation to a geographical location, e.g. a real estate agent selling a house would go through the following steps: Select the sector where the house is located. Enter the details of the house, as information for the display box 9 and the pop-up window 10, respectively. Select or enter an appropriate duration within which he can reasonably expect to sell the house. Select e.g. credit card as payment method and submit his payment details. Verify the payment.

Since different categories call for different information, the screens necessary to prompt the user for information needed would differ depending on the categories. This, however, is a mere selection of choices depending on the category of information, and is within reach for the skilled person.

In respect of the addition of pieces of information to the graphical user interface system according to the invention, it should be noted that the above interactive method where the user selects a specific sector 4 on line, is only one way doing of this. Other methods of identifying sectors 4 and adding pieces of information thereto are within the reach of the skilled person. In particular, the sectors 4 could be identified by means of their hierarchal level and their coordinates, this information then being supplied to the user. This inter alia allows transactions between the user and the provider of the graphical user interface system relating to the addition of information to be carried out off line, e.g. by paper mail or as a result of a telephone conversation.

What is claimed is:

1. A graphical user interface system for facilitating the retrieval of information relating to at least one predetermined category of information,
(a) said system comprising a computer, a user controlled pointing device and a graphic display, said graphic display comprising a number of pixels for generating an image comprising x times y pixels based on information from said computer, said image comprising a background with a superposed grid defining a number of sectors, each sector comprising a number n of pixels,
(b) said system comprising indicating means for indicating in a sector defined by said grid and displayed on said graphic display, the existence of a piece of information for that sector, where said piece of information relates to the background corresponding to that sector, and where said indicating means further indicates that said piece of information relates to said at least one category of information,
(c) said system comprising a graphical representation of a pointer movable in response to said user controlled pointing device, so as to allow user selection of a specific sector, and
(d) said system comprising means for displaying said piece of information in response to user selection of that specific sector.

2. A graphical user interface system according to claim 1, wherein said indicating means in said sector comprises one or more of: a color coding, a symbol, and blinking.

3. A graphical user interface according to claim 2, wherein a set of several different indicating means is used, each different indicating means representing a different predetermined category of information in a set of predetermined categories of information.

4. A graphical user interface according to claim 3, further comprising means for user selection between different sets of predetermined categories of information represented by said indication means.

5. A graphical user interface system according to claim 1, wherein said piece of information is automatically displayed when said graphical representation of a pointer enters a sector for which a piece of information exists.

6. A graphical user interface system according to claim 1, wherein a user controlled pointing device comprises activation means for activating the user selection of a sector in order to display said piece of information.

7. A graphical user interface system according to claim 1 wherein said background is a map and said information relating to said background is a geographical location.

8. A graphical user interface system according to claim 1, comprising means for allowing a user to add a piece of information relating to a sector, and in response to such addition have the existence of such information indicated for that specific sector.

9. A graphical user interface system according to claim 8, wherein said means for allowing the user to add a piece of information to a sector comprises an interactive process.

10. A system for facilitating the retrieval of information relating to at least one predetermined category of information,
(a) said system comprising a computer and a graphic display, said graphic display comprising a number of pixels for generating an image comprising x times y pixels based on information from said computer, said image comprising a background with a superposed grid defining a number of sectors, each sector comprising a number n of pixels,
(b) said system comprising a database with pieces of information corresponding to at least some of the sectors,
(c) said system comprising indicating means for indicating in a sector defined by said grid and displayed on said graphic display, the existence and category of a piece of information for that sector, so as to allow easy identification of potentially relevant entries in said database.

11. A system according to claim 10, further comprising a user controlled pointing device for controlling a graphical representation of a pointer movable in response to said user controlled pointing device, so as to allow user selection of a specific sector, and
(a) said system comprising means for displaying said piece of information in response to user selection of that specific sector.

12. A system according to claim 11, wherein said indicating means in said sector comprises one or more of: a color coding, a symbol, and blinking.

13. A system according to claim 10, comprising means for allowing a user to add a piece of information relating to a sector, and in response to such addition have the existence of such information indicated for that specific sector.

14. A system according to claim 13, wherein said means for allowing the user to add a piece of information to a sector comprises an interactive process.
